(19) United States
(12) Patent Application Publication
(10) Pub. No.: US 2022/0176192 A1
(43) Pub. Date: Jun. 9, 2022

(54) INCENTIVE KNEE RANGE OF MOTION EXERCISE KIT AND METHOD OF USE

(71) Applicants: Allan J Santos, Lexington, KY (US); Layne C Santos, Lexington, KY (US)

(72) Inventors: Allan J Santos, Lexington, KY (US); Layne C Santos, Lexington, KY (US)

(21) Appl. No.: 17/409,346

(22) Filed: Aug. 23, 2021

Related U.S. Application Data
(60) Provisional application No. 63/069,043, filed on Aug. 22, 2020.

(51) Int. Cl. A63B 21/00; A63B 71/06; A63B 23/04; A63B 24/00

(52) U.S. Cl. CPC A63B 21/4037; A63B 71/0622; A63B 23/0494; A63B 2220/56; A63B 24/0062; A63B 2071/0694; A63B 2071/0625; A63B 21/4039

(57) ABSTRACT

A portable exercise apparatus including an exercise board with fixed indices marking progress made while exercising a knee which requires therapy consisting of controlled flexing and extending of the knee joint. A foot board or seated foot slide cooperatively engages and slides back and forth on the exercise board. An knee/ankle platform is removably attachable to the seated foot slide providing for active or passive knee extension stretching and a short-arc quad. A knee extension pad and roll is included for use with the slide and platform. Sensing means which may include a microprocessor control box or computer or smart device with a light and/or sound device for visual and/or auditory feedback are in communication with the exercise board provide a user with the results of flexing or extending the knee by a selected controlled amount to reach his/her range of motion goal of 110-120 degrees of knee flexion.

### CROSS REFERENCE TO RELATED APPLICATIONS

This application claims priority from U.S. Provisional Application Ser. No. 63/069,043 filed on Aug. 22, 2021 and is incorporated herein in its entirety.

### TECHNICAL FIELD

The present invention relates to the field of devices which facilitate knee exercises meant to improve the range of motion and flexibility of the knee joint in rehabilitation in the prone or sitting position and incentivize the patient to reach a range of motion goal of 110-120 degrees of knee flexion.

### BACKGROUND OF THE INVENTION

When a patient has had knee surgery, especially knee replacement surgery, suggested exercises for improving the range of motion of the knee include extending and bending the knee over and over again. After surgery, the knee joint is stiff and painful to move. The joint will remain stiff until such exercises are performed regularly. Common knee exercises include performing isometric exercises consisting of manually moving the limb to be treated, while performing thrusts or counter thrusts in order to force the muscles of the limb to work and thus restore their initial flexibility, shape and quality. Exercises including flexing of the joint can give good results. However, this method of recuperation suffers from the major drawback of requiring action by a practitioner, e.g. a physiotherapist, whose professional qualifications are not essential for performing this work. A preferred exercise aid would allow a patient to exercise on his own and the patient should be able to easily and accurately measure improvement of joint motion, strength and flexibility.

Slow, continuous flexing of a joint, such as the knee, following surgery on that joint will promote rapid healing, reduce pain during healing and result in an increased range of motion of the joint. Devices for the continuous passive exercising of limbs for therapy, rehabilitation or healing often include a frame which cradles the leg within it, while the frame is driven slowly up and down with an electric motor and drive screw. This has caused difficulty as it is sometimes preferable to have the leg in a near horizontal position when it is straight. Setting and controlling the angle of flex is difficult with a frame type device.

### DESCRIPTION OF THE RELATED ART

Applicant's U.S. patent U.S. Pat. No. 10,272,291 which issued on Apr. 30, 2019 for a Knee Flexion and Extension Therapy Device and Method of Use which is incorporated herein in its entirety, describes a knee exercise embodiment whereby the extension pad is movable along a groove formed in a base.

U.S. Pat. No. 4,922,892 by Akcelrod for APPARATUS FOR RESISTIVE EXTENSION AND FLEXION OF THE LEG which issued on May 8, 1990 teaches a device including an articulating frame with receivers for holding and supporting a user's leg while the suer tries to repeatedly straighten and bend the leg. The frame is slidably mounted on a panel and includes springs which provide resistance during the exercise.

US Patent Application Publication No. 20100204620 teaches a therapy and mobility assistance system used by a patient that includes a leg device worn on the leg of the patient that provides assistance and/or resistance to enhance the mobility of the leg of the patient.

### SUMMARY OF THE INVENTION

The incentive knee range of motion flexion board is developed specifically for rehabilitation following knee replacement surgery. The invention relates to the field of devices which facilitates patients to perform knee flexion exercises and incentivizes patients to achieve the knee flexion range of motion goal of 110 to 120 degrees. A very unique feature and utilization of this device is it assures that when a patient is able to align their heel (or flexion progress bar with the flexion target goal on the foot slide board arrows for proper placement and positioning, 110 to 120 degrees of knee flexion has been achieved.

The instant invention includes a board with a removable and slidable foot pad with attached a flexion progress bar slideable on the surface of the board, and a removable and adjustable quadset pad and/or roll for providing an extension target.

In accordance with the present invention, there is provided an incentive knee range of motion exercise kit comprising, consisting of, or consisting essentially of a slide board with flexion target goal arrows, foot pad with attached flexion progress bar, quad set pad/extension target goal, knee extension roll, range of motion tracking form, and home exercise program instructions to improve the range of motion and flexibility of the knee joint in rehabilitation and incentivize the patient to reach a range of motion goal of 110-120 degrees of knee flexion.

The generally rectangular slide board has a front end, a rear end, and an upper flat surface of the generally rectangular slide board having a rounded front end and rear end having rounded corners. The front of the board includes a aperture or slot providing a handle for carrying the device. Friction means for enhancing traction with the floor surface such as rubber pads for hard surfaces and/or hook and loop elements for gripping fabric or carpet surfaces are optionally mounted on selected positions on the bottom surface of the slide board. A removable foot pad slidably engages the top surface of the board. The top surface of the board has a rear index mark comprising target arrows near the rear end of the board for alignment with a chair and have spaced apart fixed index marks at selected positions near the rear portion of the generally rectangular slide board for measuring distance of the sliding foot pad with respect to the board surface. A generally rectangular foot board slidably moves forward and backward on the top surface of the slide board. The slideable foot pad includes a rear pointer comprising a movable flexion bar extending between the side edges. The components are composed or comprises of wood, plastic, fiberglass, metal, fiberboard, corrugated cardboard and combinations thereof. Kits fabricated from corrugated cardboard, paper board, or plastic are disposable and inexpensive and useful for avoiding spreading disease and infection from one patient to another.

The knee support includes a base and an adjustable vertical tower formed from a plurality of stacked knee supporting pads affixed to a top of the slide board of selected effective height of less than the height of a knee bent with the foot and hip of the user resting horizontally on a surface. The layered pads include one or more blocks of from about 3 to 12 inches, more preferably from 5 to 10 inches an typically about 7 inches is an appropriate thickness. The present invention includes knee extension pads and height extending pads wherein the knee extension pads are from four tenths to six tenths of an inch thick.

The top layer comprises the Quad Set Pad which functions to support knee to give patient confidence to push knee/bend of the knee down toward the surface and facilitate activation of quadriceps muscle. The middle layer functions as an Extension Target to help increase knee range of motion toward achieving goal of zero degree of knee extension. The bottom layer functions as the extension target goal to help increase knee range of motion toward achieving goal of zero degree of knee extension.

The knee flexion therapy exercise device focuses on improving the knee range of motion after undergoing knee arthroplasty for promoting active effort of the patient. It promotes patient compliance with home exercises by providing a visual incentive with flexion target and extension target to monitor their progress and decreases the formation scar tissue which accumulates during healing unless the muscles are stretched and exercised by therapy. It facilitates the performance of key conventional exercises needed to achieve from 50 to 80 degree knee extension and from 100 to 120 degree and more preferably from 110 to 120 degrees of greater knee flexion especially during the acute and subacute phases of knee rehabilitation.

It is an object the present invention to provide a sliding base featuring a flexion pointer and flexion target (multi-layer or level tower of platform) to provide visual and/or sound incentive to achieve knee flexion goal wherein the flexion target can be moved close to or farther from the proximal end to set a goal and a method of measurement and calibration in order to show incremental stages of improvement.

It is an object the present invention to provide three layers of detachable extension target to provide visual and tactile incentives to achieve a knee extension goal.

It is an object the present invention to provide an exercise device wherein tension of the sliding foot board can be adjusted to add resistance for strengthening of the hamstrings.

It is an object the present invention to provide an ankle platform for static passive and active stretching providing continuous passive motion (“CPM”) movement toward terminal knee extension wherein the platform rests on the sliding board for firm support and the platform can be used as a knee platform to perform short arc quads for quadriceps strengthening.

It is an object the present invention to provide an exercise device providing a visual incentive.

It is an object the present invention to provide an exercise device which is lightweight and can be easily carried by the patient from the bed to the floor.

It is an object of the present invention to include a sensor under each pad so when adequate pressure is applied, a light and/or audible sound is activated.

It is an object of the present invention for the sensors to only count the number of times the patient is able to apply adequate pressure on each layer.

It is an object the present invention to provide an exercise device which can be used in all settings of rehabilitation including acute care, inpatient rehab, skilled nursing facility home health care, and out-patient physical therapy clinics and optionally with wireless digital goniometer.

It is an object of this invention to provide a knee exercise device which enables a patient to sit in a chair, place the foot of the injured knee on a food board, and slide the foot board forward and back to perform repetitive straightening and bending motions of the knee.

It is an object of this invention to provide a knee exercise device which provides the user with a movable pointer which measures results and notes improvements during exercise by marking the position that a user was able to move the foot board and thus giving a measure of how much the user was able to flex the knee joint.

It is an object of this invention to provide a knee exercise device which provides the user with movable target indices for marking immediate and future exercise goals.

It is an object of this invention to provide a knee exercise device which provides audible and visual feedback in the form of a light and a sound producing device such as a bell or buzzer which activates when the movable pointer moves next to the movable target index which marks the immediate goal.

It is an object of this invention to provide a knee exercise device which provides a knee/ankle support device upon which the ankle or the knee is supported and which facilitates exercises for straightening the knee joint.

It is an object of this invention to provide a knee exercise device which provides a variable thickness extension pad with an internal pressure sensor which is placed under the knee joint of a patient lying on his back and wherein the pressure switch causes a visual or sound sensor to activate when the user is able to press down on the sensor pad with enough force.

It is an object of the present invention to provide a portable knee board for isokinetic exercise.

It is an object to provide a knee exercise device for recording the number of times a patient has successfully completed a prescribed exercise.

Other objects, features, and advantages of the invention will be apparent with the following detailed description taken in conjunction with the accompanying drawings showing a preferred embodiment of the invention.

### BRIEF DESCRIPTION OF THE DRAWINGS

A better understanding of the present invention will be had upon reference to the following description in conjunction with the accompanying drawings in which like numerals refer to like parts throughout the views wherein:

FIG. 1 is a top perspective view of the knee exercise slide board with flexion target goal arrows, foot slide pad with attached flexion progress bar, quad set pad/extension target goal, and knee extension roll;

FIG. 2 is a top view of the slide board apparatus showing the slide board with flexion target goal arrows and handle;

FIG. 3 is a top view of the slide board apparatus showing the slide board with flexion target goal arrows and pads;

FIG. 4 is a bottom perspective view of the foot slide board;

FIG. 5 is a top view of the foot pad with attached Flexion progress bar;

FIG. 6 is a perspective side view of the knee extension pad with multiple stacked height extending layers;

FIG. 7 is a perspective side view of the knee extension pad showing the middle stacked height extending layers;

FIG. 8 is a perspective side view of the knee extension pad with the bottom layer;

FIG. 9 is a perspective side view of the knee extension sensor pad with multiple stacked height extending layers including sensors disposed between the layers;

FIG. 10 is a perspective view of the exercise kit including the board quad set pad, and roll;

FIG. 11 shows the flexion board includes flexion target goal arrows as indicia on the flexion board including numbers and lines providing a visual incentive for the patient to reach the flexion target goal arrows;

FIG. 12 shows a detached foot pad with flexion progress bar;

FIG. 13 shows select lines of the flexion target goal include sensors to detect when the patient's heel or flexion progress bar passes by each indicia line and the flexion target goal arrows;

FIG. 14 shows select lines of the flexion target goal include sensors to detect when the patient's heel or flexion progress bar passes by each indicia line and the flexion target goal arrows;

FIG. 15 shows select lines of the flexion target goal include sensors to detect when the patient's heel or flexion progress bar passes by each indicia line and the flexion target goal arrows;

FIG. 16 shows an Incentive Knee Range of Motion;

FIG. 17 shows the flexion progress bar is aligned with line 12;

FIG. 18 shows the flexion progress bar is aligned with line 6;

FIG. 19 shows the flexion progress progress bar is aligned with the flexion target goal arrows;

FIG. 20 shows a screen view of a hand held device with data entered during a therapy visit;

FIG. 21 shows the knee ROM tracking page wherein the ditial view of the paper tracking form;

FIG. 22 shows a paper tracking form;

FIG. 23 shows the flexion target goal arrows positioned and aligned under the bed of the operated knee;

FIG. 24 shows the flexion Progress Bar with the Flexion target goal Arrows, from 110 to 120 of knee flexion;

FIG. 25 shows the initial position of the Sitting Position exercise;

FIG. 26 shows the flexed position for the Sitting position exercise; and

FIG. 27 shows the flexion progress bar aligned with the flexion target goal arrows.

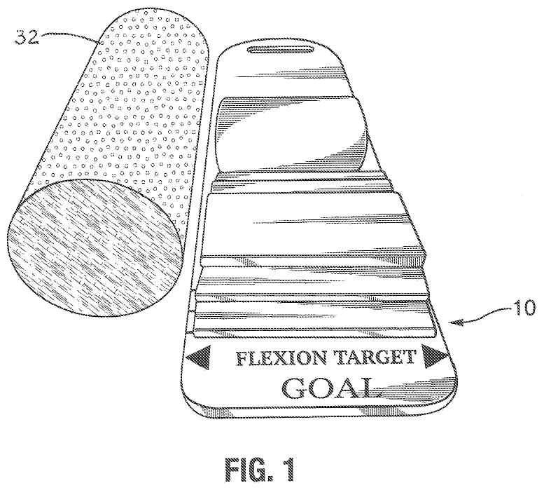

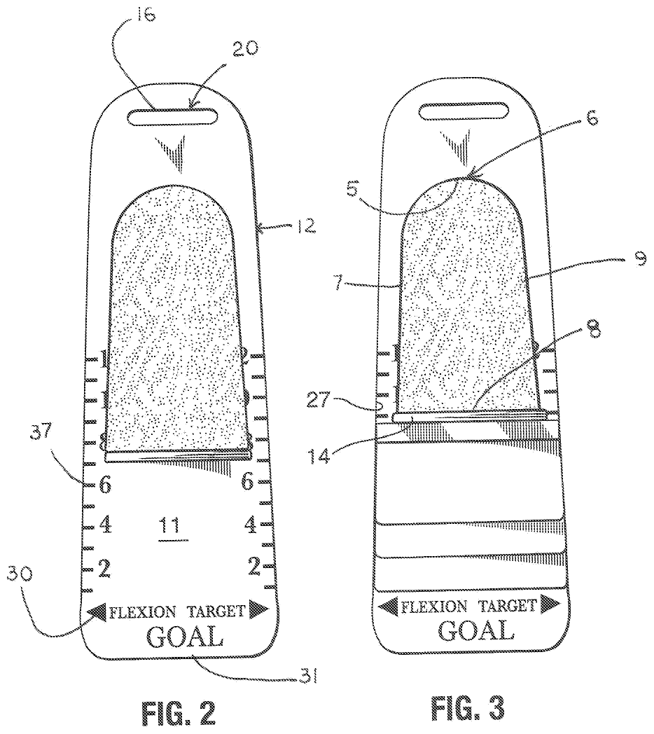

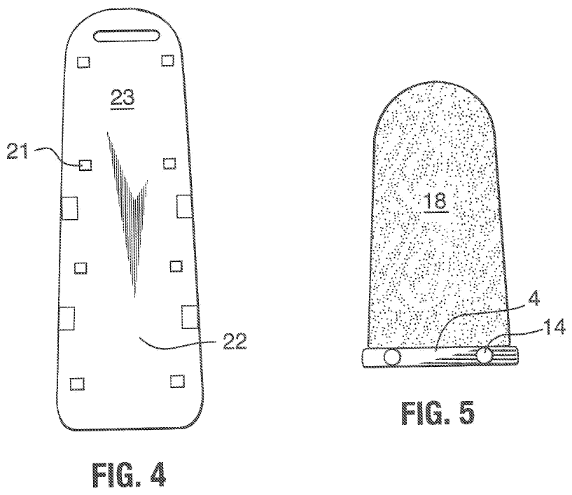

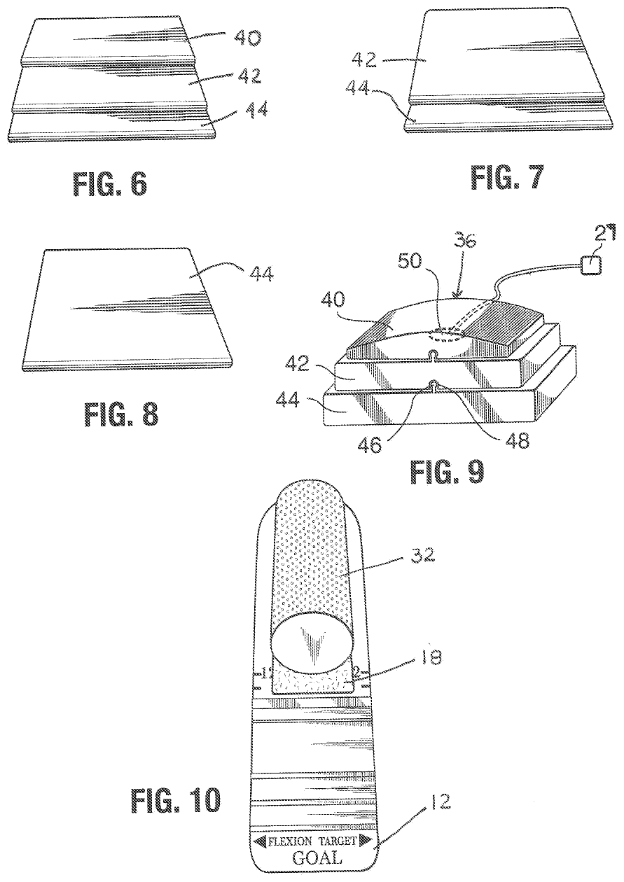

### DESCRIPTION OF THE PREFERRED EMBODIMENTS

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

As used herein, the term “about” can be reasonably appreciated by a person skilled in the art to denote somewhat above or somewhat below the stated numerical value, to within a range of ±10%.

As used herein the term “range sensing” includes one or more imaging devices including a photo eye, camera, video photo eye, scanner, laser, selected light transmission frequency or wavelength or other pixel detecting and/or digital imaging devices (collectively referred to as photo eyes).

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

The invention relates to the field of devices which facilitates patients to perform knee flexion exercises and incentivizes patients to achieve the knee flexion range of motion goal of 110 to 120 degrees.

The components are composed or comprises of wood, plastic, fiberglass, metal, fiberboard, corrugated cardboard and combinations thereof. Kits fabricated from corrugated cardboard, paper board, or plastic are disposable and inexpensive and useful for avoiding spreading disease and infection from one patient to another.

In accordance with the present invention as shown in figures, there is provided a knee exercise apparatus 10. The knee exercise apparatus 10 including a generally rectangular knee exercise slide board base 12. The slide board base 12 comprises a generally flat rectangular board. The front portion of the slide board includes a curved or parabolic shaped front end 6 connecting spaced apart side edges 7 and 9 and a straight rear end edge 8. The front of the board includes an aperture or slot 16 spaced apart from the top edge 5 providing a handle 20 for carrying the device. The top surface includes a plurality of indices 30 comprising dash lines and numbers spaced apart at selected intervals denoting distance of forward movement extending along each side edge 7, 9 of the slide board with a flexion target goal arrow extending across the slide board from side edge 7 to side edge 9 near the rear end edge 31 of the slide board. Friction means for enhancing traction with the floor surface such as rubber pads 21 for hard surfaces and/or hook and loop elements 22 for gripping fabric or carpet surfaces are optionally mounted on selected positions on the bottom surface 23 of the slide board 12.

A generally rectangular slidable foot pad 18 is supported by and in forward and rearward slidable cooperative engagement with the top surface 11 of the slide board base 12. As shown in the figures.

A resilient or soft rubber or elastomer material or fabric may also be used to cover at least a portion of the slide board or foot pad for comfortable friction enhancing means.

A flexion target goal arrows, foot pad with attached flexion progress bar serving as a movable pointer 14 positioned on the slidable foot board 18 at the rear end 4 of the slide board base 12. Marker and slide board positioning indicia or alignment lines such as hash marks are optionally formed or printed on the slide base board surface at the edge of the side edges 7 and 9 between the front end edge 5 and rear end edge 8 of the slidable board base 18.

The knee support includes a base and an adjustable vertical pad tower 36 formed from a plurality of stacked knee supporting pads affixed to a top of the slide board of selected effective height of less than the height of a knee bent with the foot and hip of the user resting horizontally on a surface. The layered pads include one or more blocks of from about 3 to 12 inches, more preferably from 5 to 10 inches an typically about 7 inches is an appropriate thickness. The present invention includes knee extension pads and height extending pads wherein the knee extension pads are from four tenths to six tenths of an inch thick.

The top layer comprises the Quad Set Pad 40 which functions to support knee to give patient confidence to push knee/bend of the knee down toward the surface and facilitate activation of quadriceps muscle. The middle layer pad 42 functions as an extension target to help increase knee range of motion toward achieving goal of zero degree of knee extension. The bottom layer pad 44 functions as the extension target goal to help increase knee range of motion toward achieving goal of zero degree of knee extension.

An extension roll can be disposed between said slide board and said foot pad.

A user aligns the target goal arrow with the front of a chair. As the user slides the foot board 18 toward the chair 59 it pushes the movable pointer 14 in a rearward direction. As the user then moves the foot pad 18 in a forward direction, the movable pointer 14 moves forward along the longitudinal axis of the slide board.

A target index 30 can be incorporated within the device to include sensing means such as an electronic sensor 27 which senses when the movable pointer 14 comes in close proximity to the target index 30 by moving past a alert sensor 27 such as a limit switch sensor, light sensor, magnetic sensor, voice activated sensor, or motion sensor. The sensor 27 in close proximity to target index 30 is electrically connected to a control box by a cable and can causes an alarm means such as a visual indicator comprising an LED light and/or sound indicator such as a buzzer to activate as the pointer 14 comes to close proximity with the sensor. It is contemplated that the intensity of the alarm increases as the distance between the sensor 27 and target index 30 decreases. As shown in the figures, target sensor 27 is placed at a point that a user considers to be a reasonable target for the present exercise session. The electronic signal is passed to smart device which maybe wireless and may record or show visual data.

Index marks 30 on either side of the slide board 12 are reference points which help the user to set the position of the exercise board 12 relative to the edge of a chair, for instance with the flexion target goal arrow 37 hash mark about six inches from the edge of the chair in which the user will be sitting. The user will sit in the same position on the chair each time he/she exercises. The positioning indicia or lines may be used for aligning the board with a support means for the users such as the front leg or front edge of a seat of a chair.

As shown in figures the injured leg is pulled back by the user using the uninjured leg; however, the therapist or other assistant often assists the patient with initial movement during therapy. The friction can be enhanced to stretch and the knee during the backward or forward motion. As shown in figures, the user places his ankle on the foot pad 18 and places the underside of the knee on the pad 40 of the knee support 32 to help flex the knee joint.

When exercising the knee by extending the knee joint, a user places the underside of his knee on a knee extension pad or spacer 40 which is positioned under the knee of the patient so that the top of the spacer or pad rest beneath the knee to support the leg. When the user touches or to depresses the knee extension pad 40, the user is performing the therapy motion properly. The knee extension pad 40 may include an internal pressure sensor 50 which is electrically connected to a control box or smart device such as a smart phone, tablet, watch, or other computer 41. When the internal pressure sensor 50 senses pressure from the downward pressure of the user's knee, the sensor 50 will activate giving viable and auditory feedback to the user that he has successfully extended his knee. Height extender pads 42 and 44 are nested and stacked to obtain the desired height and raise the knee extension pad 40 when the user is in the early stages of therapy. As the user is able to more fully extend his knee joint, the height extenders are removed to provide a more difficult extension target. The knee extension sensor pad 40 and the height extenders are preferably about four tenths to six tenths of an inch thick but may be any desired thickness depending upon the application. The knee extension pads 40 and 42 preferably include slots or sockets 48 for receiving downward extending lugs 46 in knee extension pads 42 and 44 to provide alignment and adhering of the pads to one another. The knee extension pad may include a concave center portion for supporting the underside of the leg opposite the knee.

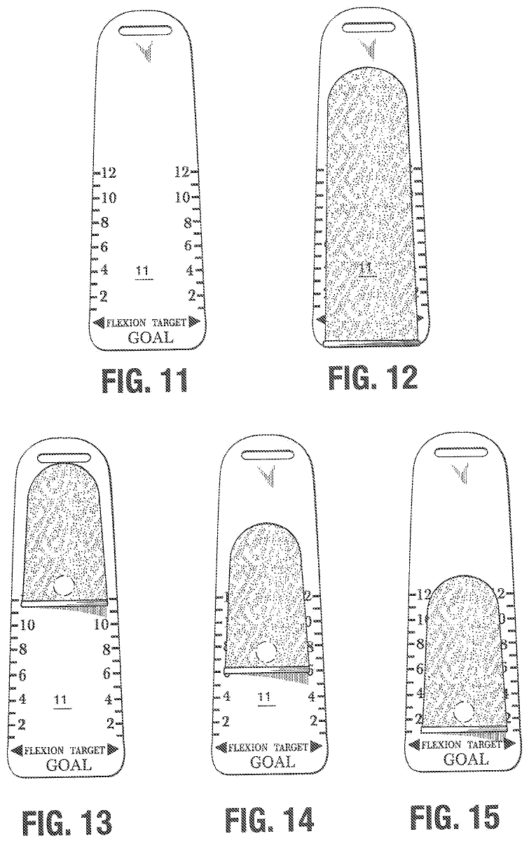

As shown in FIG. 11, the flexion board includes flexion target goal arrows as indicia on the flexion board including numbers and lines proving a visual incentive for the patient to reach the flexion target goal arrows. A detached foot pad with flexion progress bar is shown in FIG. 12.

FLEXION TARGET GOAL features are as follows:

PURPOSE: The location of the printed “FLEXION TARGET GOAL” Arrows is at the lower end of the board, and is specifically positioned so that when the patient's heel or the Flexion Progress Bar (if using the Foot Pad) aligns with the red FLEXION TARGET GOAL Arrows, the patient has reached 110 to 120 degrees of knee flexion. The goal of 110 to 120 degrees of knee flexion can be achieved in either a supine position or sitting position.

Twelve lines are marked in 1-inch increments on each side of the board; the Even Numbers (2 to 12) are printed on each side of the board.

PURPOSE: The numbers and lines provide a visual incentive for the patient to reach the FLEXION TARGET GOAL Arrows. The numbers are arranged in a descending order from 12 to 2. The lower the number the patient aligns their heel (or Flexion Progress Bar on the Foot Pad) with, the closer they are in reaching their knee flexion range of motion goal of 110 to 120 degrees.

The sliding knee board device can also be equipped with a digital wireless goniometer whereby readings are wirelessly monitored through an application on a computerized smart device such as a smart phone, smart watch, smart pad, personal computer, tablet or the like. Smart devices include smart phones which include an advanced mobile operating system which combines features of a personal computer operating system with other features useful for mobile or handheld use. It typically combines the features of a cell phone with those of other popular mobile devices, such as personal digital assistant (PDA), media player and GPS navigation unit. Most smart phones can access the Internet, have a touchscreen user interface, can run third-party apps, music players and are camera phones. Most Smart phones produced from 2012 onwards also have high-speed mobile broadband 4G LTE internet, motion sensors, and mobile payment mechanisms. The term “smart device” includes smart phones and other computerized devices including display, transmitting, and receiving means such as a visual screen, keyboard, and audio and/or visual communication with the internet or other smart devices will be referred herein as a “smart device”. Sensors positioned at selected positions on the base 12 or sliding board 18 in wireless communication with a smart device provide a means for recording and measuring the rehabilitative progress of the user. The sensors may be used to count the number of repetitions or pressure, or distance or combination thereof and transmitted to a receiver in the smart device and/or the sensor may include a microprocessor unit or other standalone digital device. The counter may also be in wireless electrical communication with a pedometer or counter in order to count repetitions. The braces or sliding boards will have attached or built in digital goniometer so patients are able to monitor their progress toward a specific motion. The benefit to the patient is the ability to visually monitor the actual range of motion of the affected joint(s).

Incentive Knee Range of Motion Flexion Board with Electrical Interface:

The addition of electronic components on the device will communicate and send signals to a mobile device. This incentivizes the patient to achieve their knee flexion range of motion goal of 110 to 120 degrees by providing an audiovisual feedback.
1. The Incentive Knee Range Of Motion Flexion Board is equipped with a microchip which is able to communicate/send signals to a Mobile Device using Incentive Knee Range Of Motion (iKROM) Mobile App; and
2. The Incentive Knee Range Of Motion Flexion Board will have Electronic Sensors on the 12 lines and Flexion Target Goal Arrows on each side of the board which are able to detect the motion of the patient's heel or Flexion Progress Bar.

In FIGS. 13-15 select lines of the flexion target goal include sensors to detect when the patient's heel or flexion progress bar passes by each indicia line and the flexion target goal arrows. The movement of the patient's hell (or flexion progress bar) is detected by sensors on the lines and the flexion goal arrows.

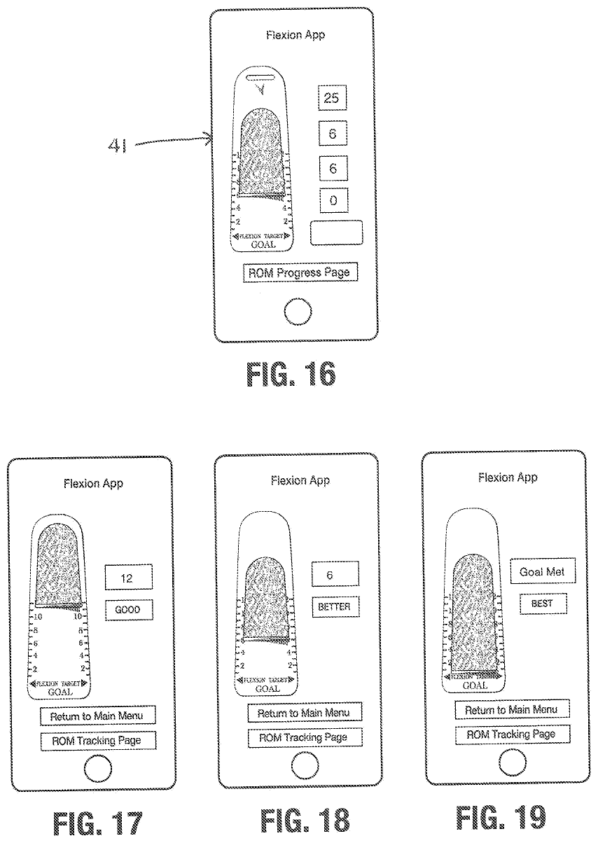

A hand held device such as a smart phone or tablet having a display can be used to monitor the activities. As shown in FIG. 16, an Incentive Knee Range of Motion (iKROM application) features:
1. Left side of the mobile device screen illustrates the dynamic electronic image of the iKROM board and Foot Pad with Flexion Progress Bar; Numbers (even numbers from 2 to 12), 12 lines on each side of the board and FLEXION TARGET GOAL Arrows;
2. Right side of the mobile device screen: 4 dynamic digital recording boxes including:

1^{st} Digital Box: Records the number of times the heel (or flexion progress bar) slides toward the flexion target goal arrows when the patient slides their foot back and forth (Note: when the patient slides their foot back and forth, the device detects two passes, but the box will only record a selected backward or forward movement toward the flexion target goal arrows;

2^{nd} Digital Box: Records dynamically the distance (in inches or centimeters) of the heel (or flexion progress bar) as it passes each line toward the flexion target goal arrows;

3^{rd} Digital Box: Records dynamically the distance (in inches or centimeters or other selected unit of measurement) from the heel (or flexion progress bar) to the flexion target goal arrows with the numbers arranged in descending order, whereby the lower the number, the closer the patient is to reaching the flexion target goal arrows; and

4^{th} Digital Box: Records the number of times the heel (or flexion progress bar) aligns with or passes the flexion target goal arrows;

Bottom of the mobile device screen includes a Reset button (to reset the numbers on the digital recording boxes); and

The device also includes a ROM Progress Page button. When the button is pressed a page appears giving patient visual incentive that he/she is making progress.

Benefits of Incentive Knee Range of Motion (iKROM) Flexion Board
1) It is easy to use: facilitates patient compliance with home exercise program;
2) It will incentivize patients to achieve knee range of motion goals using audiovisual feedback;
3) It is light-weight and designed for home use: It can easily be carried by the patient from the bed/couch to the floor;
4) The iKROM Flexion Board facilitates key conventional exercises to increase knee flexion following knee replacement surgery;
a) Seated assisted foot slides with knee flexion stretching;
b) Supine heel slides: Facilitates active knee flexion range of motion exercise and increases strength of hamstrings muscles;
c) Seated active foot slides: Facilitates active knee flexion range of motion exercise and increases strength of hamstrings muscles; and
   5) If positioned and aligned as instructed, the board also acts as a tool to check if the patient has achieved knee range of motion between 110 to 120 degrees of flexion.

When the ROM progress bar is pressed a page appears giving the patient visual incentive that he/she is making progress. As shown in FIGS. 17-19, the digital Box #3 is highlighted and translated to GOOD, BETTER, BEST giving the patient visual incentive that he/she is making progress, wherein in FIG. 17 the flexion progress bar is aligned with line 12, in FIG. 18 the flexion progress bar is aligned with line 6, and in FIG. 19 the flexion progress progress bar is aligned with the flexion target goal arrows.

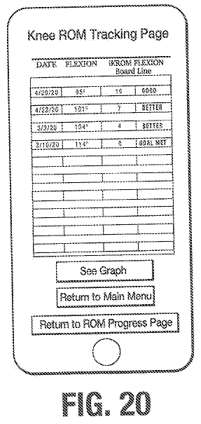

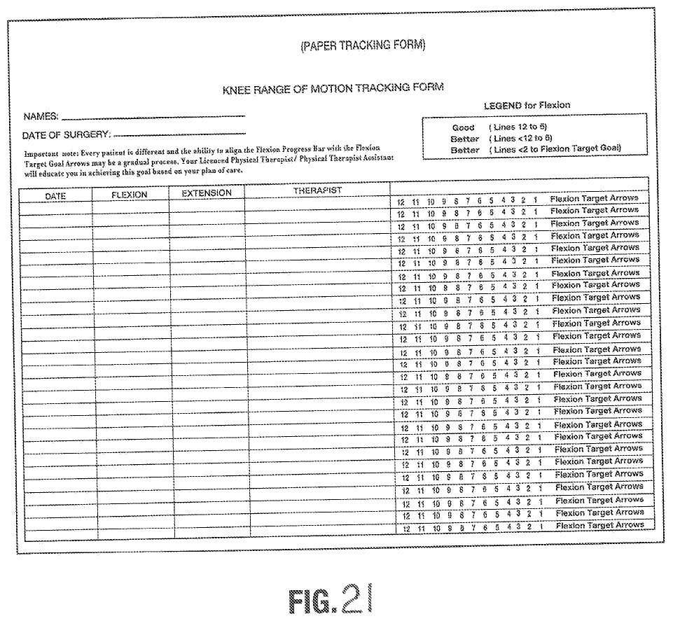

When the Knee ROM Tracking Page button is pressed, a view will appear on the screen as shown in FIG. 20 whereby columns 3 & 4 are automatically filled in according to the patient's progress using the iKROM Flexion Board. Columns 1 & 2 are manually entered by the patient using therapist's goniometric measurement during therapy visit.

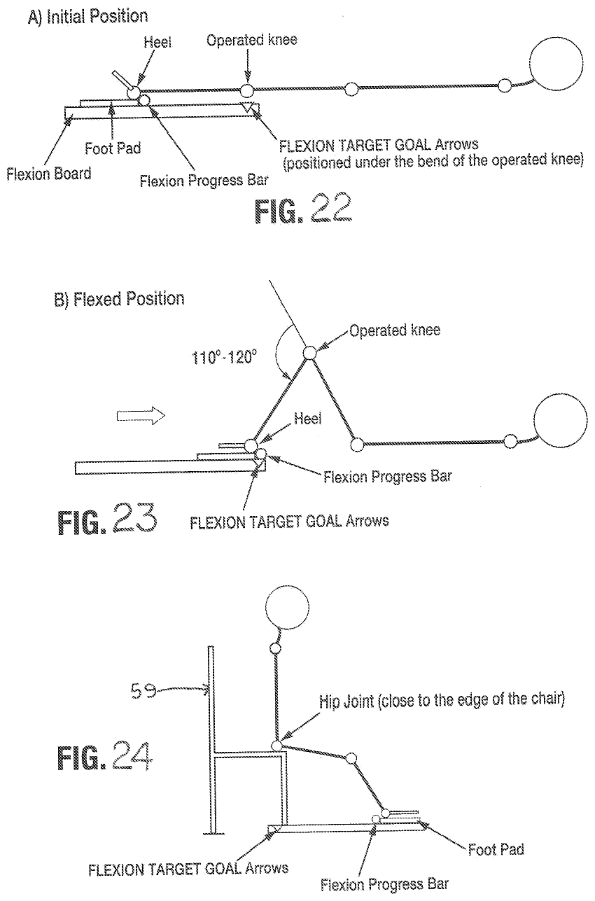

The knee ROM tracking page is shown in FIG. 21 wherein the ditial view of the paper tracking form is shown. The 1^{st} column shows the date of data entry; the 2^{nd} column shows the flexion ROM (from the range of motion measured by the therapist); the 3^{rd} column records the number corresponding to the 3^{rd} digital box which is the closest distance in inches from the flexion progress bar to the flexion target goal arrows; and the 4^{th} column shows the legend as GOOD, BETTER, or BEST/GOAL MET. A Paper Tracking Form is shown in FIG. 22.

### Test 1

Knee Flexion Board can be Used to Determine if Patient Met their Goal of 110 to 120 Degrees of Knee Flexion.

SUPINE POSITION (see 110 Knee Flexion Test)

a) Position iKROM knee flexion board under the operated leg

b) FLEXION TARGET GOAL Arrows are positioned and aligned under the bend of the knee; and

c) Place the FOOT PAD under the heel of the operated leg so heel is positioned in front of and touching the Flexion Progress Bar (FPB).

The flexion target goal arrows are positioned and aligned under the bed of the operated knee as shown in FIG. 23.

The flexion Progress Bar with the FLEXION TARGET GOAL Arrows, then the patient will have reached 110 to 120 of knee flexion as shown in the Flexed Position in FIG. 24.

Sitting Position

a) Choose a sturdy chair that is approximately the same height as the length of the patients femur (thigh bone) or ¼ of patient's height; and

b) Scoot the patient forward so that the hips are close to the edge of the chair.

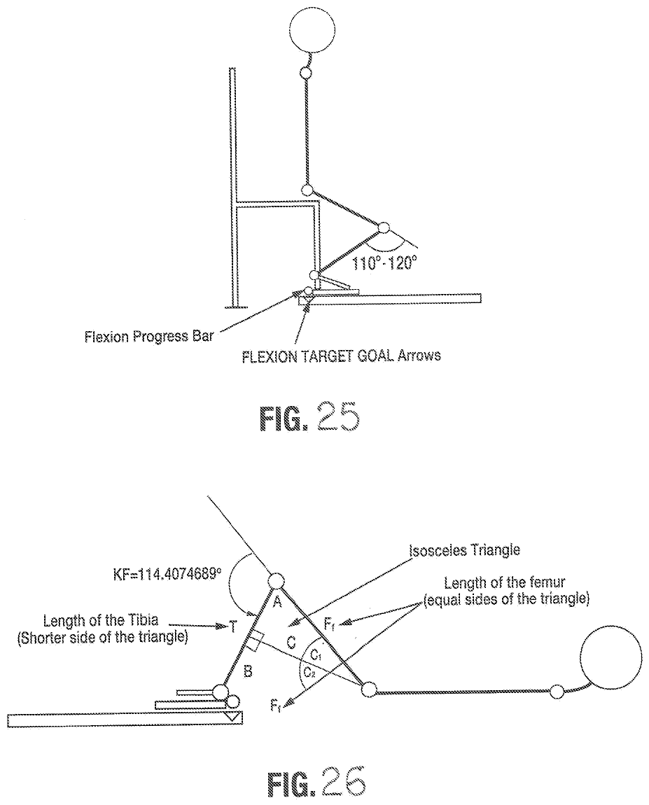

The Initial Position is shown in FIG. 25. In the flexed position shown in FIG. 26, the flexion board is shown with the patient positioned so the flexion target goal arrows are directly under the hip joint.

When the patient is able to align the Flexion Progress Bar with the flexioin target goal arrows, then the patient will have reached 110 to 120 of knee flexion.

### Test 2

The invention claims that when the FLEXION TARGET GOAL Arrows are positioned as instructed, and the patient is able to align the Flexion Progress Bar with the FLEXION TARGET GOAL Arrows, the patient will have reached 110 to 120 of knee flexion.

Use of Geometric Formula and Calculation:

1) Facts/Measurements:
a) Femur (thigh bone) length and Tibia (lower leg bone) has 1.21 length ratio
   Reference: Journal of Anatomy Published online
   J Anat. 203 May; 222(5): 526-537
   Published online 2013 Mar. 22. Doi: 10.1111/joa.12041
   Web link: https://www.ncbi.nlm.nih.gov/pmc/articles/PMC3633342/
   Excerpt from the above article: “Length ratios of femur: tibia and humerus: ulna were remarkably similar (1.21 and 1.22, respectively) and varied little (<7%) between individuals.”
b) Femur (thigh bone) length is ¼ of the Height of a person
   Reference: The FASEB Journal
   Determination of Height Using Femur Length
   Web link: https://www.fasebj.org/doi/abs/10.1096/fasebj.29.1_supplement.lb19
   Excerpt from the above article: “This study revealed that the height of an individual is four times the femur length of the individual, since the femur length is proportional to the height, therefore the taller the individual the longer femur length, while the shorter the individual the shorter the femur length.”

a) Geometric formula
When the iKROM Flexion Board is positioned as instructed, and the Flexion Progress Bar is aligned with FLEXION TARGET GOAL Arrows, an Isosceles Triangle is created as illustrated in FIG. 27 in supine position:

Angles and Sides of the Isosceles Triangle

KF (knee flexion) angle=180 minus angle A

Angle C₁=Angle C₂

Angle C₁ plus Angle C₂=C Angle (Vertex of isosceles triangle)

Angles A and B=2 congruent base angles of the isosceles triangle

Fᵢ=femur length (initial position)

F_{f}=femur length (flexed position)

T=Length of Tibia

Constant Values and Formula:

Ratio of Femur: Tibia=1.21

T (length of tibia)=F (Length of Femur)/1.21

F (Length of Femur)=¼ of the Height of a person

Variable Values: Person's height

Geometric Formula to Find the Knee Flexion ROM of 114.4074689

$$Sin {C}_{1} = \frac{( T \text{/} 2 )}{F}$$

$${Sin}^{- 1} {C}_{1} = {Sin}^{- 1} \frac{( T \text{/} 2 )}{F}$$

$$Angle {C}_{1} = {Sin}^{- 1} \frac{( T \text{/} 2 )}{F}$$

$$Angle C = C 1 \times 2$$

Angle A plus Angle B=180−Angle C

(180−Angle C) Divided by 2=Angle A or Angle B

Knee Flexion (KF) ROM=180−Angle A or Angle B

Knee Flexion (KF) ROM=114.4074689

Example A: Apply the above formula to a person whose height is 5′8″ (68 inches)
Step 1: Determine the length of Femur and Tibia

$$a ) F ( Length of femur ) = {68}^{″} \text{/} 4 = {17}^{″} \\ b ) T ( Length of tibia ) = {17}^{″} \text{/} 1.21 = {14.04958678}^{″}$$

Step 2: Using the above formula, find the angle of Knee Flexion ROM when the patient's Heel (or Flexion Progress Bar) is aligned with FLEXION TARGET GOAL Arrows

$${Sin}^{- 1} {C}_{1} = {Sin}^{- 1} \frac{( {14.0495878}^{″} \text{/} 2 )}{{17}^{″}} = 24.40746892 = {C}_{1}$$

$${C}_{1} \times 2 = Angle C = 24.40746892 \times 2 = 48.81493784$$

$$Angle A + Angle B = 180 - Angle C = 180 - 48.81493784 = 131.1850622$$

$$( 180 - Angle C ) Divided by 2 = Angle A or Angle B = 131.1850622 \text{/} 2 = 65.59253108$$

$$Knee Flexion ( KF ) ROM = 180 - Angle A or Angle B = 180 - 65.59253108 = Knee Flexion ( KF ) ROM = 114.4074689$$

Example B: Apply the above formula to a person whose height is 5′0″ (60 inches)

Step 1: Determine the length of Femur and Tibia

$$a . F ( Length of femur ) = {60}^{″} \text{/} 4 = {15}^{″}$$

$$b . T ( Length of tibia ) = {15}^{″} \text{/} 1.21 = {12.3966942}^{″}$$

Step 2: Using the above formula, find the angle of Knee Flexion ROM when the patient's Heel (or Flexion Progress Bar) is aligned with FLEXION TARGET GOAL Arrows

$${Sin}^{- 1} {C}_{1} = {Sin}^{- 1} \frac{{12.3966942}^{″} \text{/} 2 )}{{15}^{″}} = 24.40746892 = {C}_{1}$$

$${C}_{1} \times 2 = Angle C = 24.40746892 \times 2 = 48.81493784$$

$$Angle A + Angle B = 180 - Angle C = 180 - 48.81493784 = 131.1850622$$

$$( 180 - Angle C ) Divided by 2 = Angle A or Angle B = 131.1850622 \text{/} 2 = 65.59253108$$

$$Knee Flexion ( KF ) ROM = 180 - Angle A or Angle B = 180 - 65.59253108 = Knee Flexion ( KF ) ROM = 114.4074689$$

Note: According to the above geometric formula, regardless of height, if the patient is able to align the Flexion Progress Bar with the FLEXION TARGET GOAL Arrows, patient will have achieved 110 to 120 of knee flexion.

### Test 3

### 110 Degree Knee Flexion Test

Purpose: The purpose of this test is to determine if a patient has reached 110 degrees or more of Knee Flexion.
To perform the test:

1) With iKROM Knee Flexion Board:
Position iKROM KNEE FLEXION BOARD under the operated leg
FLEXION TARGET GOAL Arrows are positioned and aligned under the bend of the knee
Place the FOOT PAD under the heel of the operated leg so heel is positioned in front of and touching the Flexion Progress Bar
When the FLEXION TARGET GOAL Arrows are positioned as instructed, and the patient is able to align the Flexion Progress Bar with the FLEXION TARGET GOAL Arrows, the patient will have reached between 110 and 120 of knee flexion.

1) Without the iKROM Knee Flexion Board:
Lie flat on a firm surface
Mark the surface under the bend of the knee
Slide the heel of the knee being tested toward the marked surface
When the back of the heel touches the marked surface, the patient will have reached between 110 and 120 of knee flexion.

Examples of exercise instructions to be followed in therapy sessions using the knee exercise system are set forth hereafter.

The following examples describe preferred embodiments of the invention. Other embodiments within the scope of the claims herein will be apparent to one skilled in the art from consideration of the specification or practice of the invention as disclosed herein. It is intended that the specification, together with the examples, be considered exemplary only, with the scope and spirit of the invention being indicated by the claims which follow the examples. In the examples all percentages are given on a weight basis unless otherwise indicated.

### Set-Up for Knee Flexion Exercises

### Knee Flexion Range Of Motion Goal: 110 Degrees

A firm chair is used with the back of the chair positioned against a wall or counter or other immovable object. Position the knee exercise device 10 on the floor with the black marker lines in line with the edge 60 of the chair 59 so that the main board extends out in front.

The user sits close to the edge of the chair and the foot of the injured leg is placed on top of the foot board with the flexion pointer bar next to the foot board.

The knee exercise is equipped with two flexion targets (markers), one on each side of the main board. Coordinate the setting of the flexion targets with the physical therapist and determine the short term and long term goals. (An example would be setting the left flexion target for a two week goal and the right flexion target for a four week goal).

The goal is to push the flexion pointer bar in line with or past the flexion target. As the flexion pointer bar is pushed further back, it is possible to quantify the progress in flexing the operated knee.

### Incentive Knee Flexion Target Board Quick Exercise Guide

### Legend:

Good: (Lines 12 to 6)
Better: (Lines <6 to 2)
Best: (Lines <2 to Flexion Target Arrows)

### Exercise Example 1

Supine Heel Slides/Active Knee Flexion Using iKROM Flexion Board and Foot Pad (Supine Active Knee Flexion)
Purpose of exercise: Increases range of motion toward flexion and increases strength of your hamstring muscles (muscles under your thigh)
1. Position the Flexion Target Arrows on the iKROM™ Flexion Board directly under the bend of the knee.
2. Place your heel/foot of your operated leg on top of the Foot Pad with your heel against and in front of the Flexion Progress Bar.
3. Keep your hip down on the bed or couch.
4. Slowly slide Foot Pad back and forth pushing toward Flexion Target Goal Arrows.
5. Perform 10-20 repetitions 2-3 times a day (or as instructed by your cal Therapist or Physical Therapist Assistant)
ULTIMATE GOAL: Align the Flexion Progress Bar with the Flexion Target Goal Arrows to reached 110 to 120 degrees of knee flexion.

### Exercise Example 2

Seated Assisted Knee Flexion Stretching
Purpose of exercise VERY IMPORTANT EXERCISE to increase range of motion toward achieving goal of 110 to 120 degrees of knee flexion
   1. Use a firm chair, preferably with an armrest and place the back of the chair against a wall or counter.
   2. In seated position, scoot forward close to the edge of your chair; you can place a pillow(s) against your lower back for support.
      Position the iKROM™ Flexion Board on the floor with the red Flexion Target Goal Arrows in line with your hips so that the portion of the board with the handle extends out in front
   3. Place the foot of the operated leg on top of the Foot Pad with your heel st and resting in front of the Flexion Progress Bar. Your starting position will be where your operated knee is flexed without discomfort.
   4. Slowly bend your operated leg by sliding the Foot Pad backwards as much as you can
   5. Assist knee flexion by pushing your operated lower leg back using the un-operated leg
   6. Hold stretch for 5 seconds. Your therapist or your caregiver can also assist with this exercise
   7. Perform 10-20 repetitions 2-3 times a day (or as instructed by your Physical Therapist or Physical Therapist Assistant)
ULTIMATE GOAL: To align the Flexion Progress Bar with the Flexion Target Goal Arrows; you will have reached 110 to 120 degrees of knee flexion

### Exercise Example 3

### Seated Knee Flexion/Seated Foot Slides (Seated Active Knee Flexion)

The purpose of exercise: Another VERY IMPORTANT EXERCISE to increase range of motion toward achieving goal of 110 to 120 degrees of knee flexion and increase strength of the Hamstrings
1. Place foot of the operated leg on the Foot Pad and slide foot backward and forward
2. Perform 10-20 repetitions 2-3 times per day (or as instructed by your Physical Therapist/Physical Therapist Assistant). Progress gradually until you can slide foot further backward.
ULTIMATE GOAL: To align the Flexion Progress Bar with the Flexion Target Goal Arrows; you will have reached 110 to 120 degrees of knee flexion

### Exercise Example 4

### Quad Sets/Knee Press Using Quad Set Pad/Extension Target Foam

The purpose of exercise is to help activate quadricep muscles (muscles on top of your thigh) and increase active knee extension.
1. With Quad Set Pad/Extension Target Foam under the bend of your knee use Three-Layers pushing bend of knee down on the top layer (Quad set pad)
2. Push down and hold for 3-5 seconds,

Perform 10-20 repetitions 2-3 times a day

(or as instructed by your Physical Therapist or Physical Therapist Assistant) Two-Layers pushing bend of knee down on middle layer (Extension Target)

1. Push knee down and hold for 3-5 seconds,

2. Perform 10-20 repetitions 2-3 times a day

(or as instructed by your Physical Therapist or Physical Therapist Assistant)

### One-Layer Pushing Bend of Knee Down on Bottom Layer (Extension Target Goal)

1. Push knee down and hold for 3-5 seconds,

2. Perform 10-20 repetitions 2-3 times a day

(or as instructed by your Physical Therapist or Physical Therapist Assistant)

### Exercise Example 5

Active Knee Extension Stretching Using the Knee Extension Roll
Purpose of exercise: VERY IMPORTANT EXERCISE to increase range of motion toward achieving goal of 0 of knee extension and increase strength of quadriceps muscles.
Note: If you initially have difficulty lifting your leg by yourself, you can use a leg lifter or have a caregiver assist you to lift up your leg
   1. Position Knee Extension Roll (with foot pad on top for comfort) under the ankle of operated knee,
   2. Push knee down and hold for 3-5 seconds,
   3. Perform 10-20 repetitions 2-3 times a day or more (or as instructed by your Physical Therapist or Physical Therapist Assistant)

Passive Knee Extension Stretching Using the Knee Extension Roll
Purpose of exercise: VERY IMPORTANT EXERCISE to increase range of motion toward achieving goal of 0 of knee extension
   1. Position iKROM Knee Extension Roll (with foot pad on top for comfort) under the ankle of operated knee,
   2. Relax muscles and maintain this position for 10 to 15 minutes 2-3 times a day (or as instructed by your Physical Therapist or Physical Therapist Assistant)
   3. Stop this exercise if you are experiencing abnormal pain and discuss alternative approach with your therapist to increase knee extension range of motion

Ankle Pumps Using Knee Extension Roll Under Your Heel (You May Need to Use Your Leg Lifter or have Someone Help You to Raise Your Leg Up to Place Your Ankle on Top of Knee Extension Roll)
Purpose of exercise: Increases circulation in lower legs, decreases swelling and helps prevent blood clots
   1. Raise toes up and hold for 3 seconds, then
   2. Point toes down and hold 3 seconds
   3. Do 10-20 times every hour during the day (or as instructed by your Physical Therapist or Physical Therapist Assistant)

Short Arc Quads/Terminal Knee Extension Using the Knee Extension Roll
Purpose of exercise: Increases strength of quadriceps to keep knee from buckling when walking and standing
   1. Tighten the muscles on top of your thigh (your quadricep muscles) as you straighten your knee.
   2. Hold this position for 3-5 seconds, and then slowly return to the starting position.
   3. Perform 10-20 repetitions 2-3 times a day (or as instructed by your Physical Therapist or Physical Therapist Assistant)

### Exercise Example 6

### Exercises Performed Lying on Your Back or Reclined Position

Quad sets/knee press using quad set pad/knee extension Target Foam
Purpose of exercise: Helps activate quadricep muscles (muscles on top of your thigh) and increase active knee extension
With Quad Set Pad/Extension Target Foam under the bend of your knee
Three-Layers pushing bend of knee down on the top layer (Quad set pad)
   1. Push down and hold for 3-5 seconds,
   2. Perform 10-20 repetitions 2-3 times a day
(or as instructed by your Physical Therapist or Physical Therapist Assistant)
Two-Layers pushing bend of knee down on middle layer (Extension Target)
   1. Push knee down and hold for 3-5 seconds
   2. Perform 10-20 repetitions 2-3 times a day
(or as instructed by your Physical Therapist or Physical Therapist Assistant)
One-Layer pushing bend of knee down on bottom layer (Extension Target Goal)
   1. Push knee down and hold for 3-5 seconds,
   2. Perform 10-20 repetitions 2-3 times a day
(or as instructed by your Physical Therapist or Physical Therapist Assistant)

### Exercise Example 7

Active Knee Extension Stretching Using the iKROM™ Knee Extension Roll
Purpose of exercise: VERY IMPORTANT EXERCISE to increase range of motion toward achieving goal of 0 of knee extension and increase strength of quadricep muscles.
Position iKROM™ Knee Extension Roll (with foot pad on top for comfort) under the ankle of operated knee,
   1. Push knee down and hold for 3-5 seconds,
   2. Perform 10-20 repetitions 2-3 times a day or more (or as instructed by your Physical Therapist or Physical Therapist Assistant)

Short Arc Quads/Terminal Knee Extension
Purpose of exercise: Increases strength of quadriceps to keep knee from buckling when walking and standing
1. Tighten the muscles on top of your thigh (your quadricep muscles) as you straighten your knee.
2. Hold this position for 3-5 seconds, and then slowly return to the starting position. Perform 10-20 repetitions 2-3 times a day (or as instructed by your Physical Therapist or Physical Therapist Assistant)
Note: If you initially have difficulty lifting your leg by yourself, you can use a leg lifter or have a caregiver assist you to lift up your leg
   Legend:
   Good: (Lines 12 to 6)
   Better: (Lines <6 to 2)
   Best: (Lines <2 to Flexion Target Arrows)

### Exercise Example 8

Supine Heel Slides/Active Knee Flexion Using iKROM™ Flexion Board and Foot Pad
Purpose of exercise: Increases range of motion toward flexion and increases strength of your hamstring muscles (muscles under your thigh)
1. Position the Flexion Target Goal Arrows on the iKROM™ Board directly under the bend of the knee.
2. Place your heel/foot of your operated leg on top of the Foot Pad with your heel against and in front of the Flexion Progress Bar.
3. Keep your hip down on the bed or couch.
4. Slowly slide Foot Pad back and forth pushing toward Flexion Target Goal Arrows.
Perform 10-20 repetitions 2-3 times a day (or as instructed by your Physical Therapist or Physical Therapist Assistant)
ULTIMATE GOAL: Align the Flexion Progress Bar with the Flexion Target Goal Arrows; you will have reached 110 to 120 degrees of knee flexion

### Exercise Example 9

Passive Knee Extension Stretching Using the iKROM™ Knee Extension Roll
Purpose of exercise: VERY IMPORTANT EXERCISE to increase range of motion toward achieving goal of 0 of knee extension
1. Position Knee Extension Roll (with foot pad on top for comfort) under the ankle of operated leg
2. Relax muscles and maintain this position for 10 to 15 minutes 2-3 times a day (or as instructed by your Physical Therapist or Physical Therapist Assistant)
Stop this exercise if you are experiencing abnormal pain and discuss alternative approach with your Physical Therapist/Physical Therapist Assistant to increase knee extension range of motion

### Exercise Example 10

Exercises Performed in Sitting Position
IMPORTANT NOTE: Every patient recovers differently, and the ability to align the Flexion Progress Bar with Flexion Target Goal Arrows may be a gradual process. Your licensed Physical Therapist/Physical Therapist Assistant will educate you in achieving this goal based upon your plan of care. DO NOT attempt to align the Flexion Progress Bar with the Flexion Target Goal Arrows if you are experiencing abnormal pain or if your surgeon gave a knee range of motion restriction.

Seated Assisted Knee Flexion Stretching
Purpose of exercise: VERY IMPORTANT EXERCISE to increase range of motion toward achieving goal of 110 to 120 degrees of knee flexion
   Use a firm chair, preferably with an armrest and place the back of the chair against a wall or counter to stabilize
      1. In seated position, scoot forward close to the edge of your chair; you can place a pillow(s) against your low back for support.
      2. Position the iKROM™ Flexion Board on the floor with the red Flexion Target Goal Arrows in line with your hips so that the portion of the board with the handle extends out in front
      3. Place the foot of the operated leg on top of the Foot Pad with your heel resting against and in front of the Flexion Progress Bar. Your starting position will be where your operated knee is flexed without discomfort.
      4. Slowly bend your operated leg by sliding the Foot Pad backwards as much as you can Assist knee flexion by pushing your operated lower leg back using the un-operated leg
      5. Hold stretch for 5 seconds. Your physical therapist or your caregiver can also assist with this exercise
   Perform 10-20 repetitions 2-3 times a day (or as instructed by your Physical Therapist or Physical Therapist Assistant)
ULTIMATE GOAL: To align the Flexion Progress Bar with the Flexion Target Goal Arrows; you will have reached 110 to 120 degrees of knee flexion

### Exercise Example 11

Seated Knee Flexion/Seated Foot Slides (Seated Active Knee Flexion)
Purpose of exercise: Another VERY IMPORTANT EXERCISE to increase range of motion toward achieving goal of 110 to 120 degrees of knee flexion and increase strength of the hamstrings
   Put foot of the operated leg on the Foot Pad and slide foot backward and forward for 10-20 times
   Perform 2-3 times per day (or as instructed by your therapist). Progress gradually until you can slide foot further backward.
ULTIMATE GOAL: To align the Flexion Progress Bar with the Flexion Target Goal Arrows; you will have reached 110 to 120 degrees of knee flexion

### Exercise Example 12

Seated Foot Slides for Knee Flexion Range of Motion
(Active Knee Flexion)—Flexion goal 110-120 degrees

The foregoing detailed description is given primarily for clearness of understanding and no unnecessary limitations are to be understood therefrom, for modification will become obvious to those skilled in the art upon reading this disclosure and may be made without departing from the spirit of the invention and scope of the appended claims. Accordingly, this invention is not intended to be limited by the specific exemplification presented herein above. Rather, what is intended to be covered is within the spirit and scope of the appended claims.

1. A knee flexion and extension incentive therapy device, comprising:
a generally rectangular slide board base having a front end and a rear end, said generally rectangular slide board having an upper flat surface including fixed target indices defining a flexion target and an extension target;
a foot pad resting horizontally on said flat upper surface of said slide board is slidably received thereon for forward and rearward sliding motion;
a movable progress bar slidably extending laterally from a rear end of said foot board;
a knee/ankle support including a base, a plurality of stacked knee/ankle support pads supported by said slide board forming a variable vertical extension between an underside of a user's knee and a supporting surface of said foot board, said base having a selected effective height of less than the height of said user's knee bent with the foot and hip of the user positioned horizontally with respect to said slide board for 50 to 80 degrees of knee extension and from 0 to 110 degrees or greater knee flexion during knee rehabilitation; and
said foot board having a top surface capable of supporting a foot of a user and including means for securing a bottom of said slide board to a flat surface.

2. The knee flexion and extension incentive therapy device defined in claim 1 wherein said knee/ankle support including a base, a plurality of stacked support pads including downward extending lugs.

3. The knee flexion and extension incentive therapy device defined in claim 1 wherein said knee extension pad contains a pressure sensor which is electrically connected to said control box, said control box including a light capable of being activated by said pressure sensor when a user's knee presses against said knee extension pad.

4. The knee flexion and extension incentive therapy device defined in claim 1 including an extension roll disposed between said slide board and said foot pad.

5. The knee flexion and extension incentive therapy device defined in claim 4 wherein said knee extension pad contains a pressure sensor which is electrically connected to said control box, said control box including an audible alarm capable of being activated by said pressure sensor when a user's knee presses against said knee extension pad.

6. A knee flexion and extension incentive therapy device comprising:
a generally rectangular slide board having a front end and a rear end, said generally rectangular slide board having an upper flat surface having indexing means at selected positions along said generally rectangular slide board;
a generally rectangular slidable foot pad resting horizontally on said flat upper surface of said slide board slidably received thereon; and
said slidable foot pad having a top surface capable of supporting a foot of a user and including means of receiving and cooperatively engaging means for removably holding a knee/ankle support member.

7. The knee flexion and extension incentive therapy device of claim 6, wherein including an extension roll disposed between said slide board and said foot pad.
